(19) United States
(12) Patent Application Publication
(10) Pub. No.: US 2024/0429436 A1
(43) Pub. Date: Dec. 26, 2024

(54) ALL-SOLID-STATE SECONDARY BATTERY AND MANUFACTURING METHOD THEREFOR

(71) Applicant: SAMSUNG SDI CO., LTD., Yongin-si, Gyeonggi-do (KR)

(72) Inventors: Minsuk LEE, Yongin-si, Gyeonggi-do (KR); Kwangjong SUH, Yongin-si, Gyeonggi-do (KR); Younggyoon RYU, Yongin-si, Gyeonggi-do (JP); Jaegu YOON, Yongin-si, Gyeonggi-do (JP)

(21) Appl. No.: 18/690,037

(22) PCT Filed: Sep. 6, 2022
(86) PCT No.: PCT/KR2022/013329

§ 371 Date: Mar. 7, 2024

(30) Foreign Application Priority Data
Sep. 8, 2021 (KR) 10-2021-0119855

(51) Int. Cl. H01M 10/056; H01M 4/02; H01M 4/36; H01M 4/38; H01M 4/587; H01M 50/426; H01M 50/431; H01M 50/446

(52) U.S. Cl. CPC H01M 10/056; H01M 4/364; H01M 4/38; H01M 4/587; H01M 50/426; H01M 50/431; H01M 50/446; H01M 2004/021; H01M 2004/027; H01M 2300/0091

(57) ABSTRACT

Provided are an all-solid-state secondary battery including a cathode layer, an anode layer, and a solid electrolyte layer disposed between the cathode layer and the anode layer, wherein the solid electrolyte layer includes a sulfide-based solid electrolyte and inorganic particles, wherein the inorganic particles have an average particle diameter of 50 nm to 5 μm or less, and a method of manufacturing the same.

### TECHNICAL FIELD

The disclosure relates to an all-solid-state secondary battery and a method of manufacturing the all-solid-state secondary battery.

### BACKGROUND ART

Recently, in accordance with industrial demand, batteries having high energy density and high safety have been actively developed. For example, lithium ion batteries are put to practical use not only in the fields of information-related devices and communication devices, but also in the field of vehicles. In the fields of vehicles, safety may be especially important because the vehicles are related to life.

Lithium ion batteries currently on the market use an electrolyte including a flammable organic solvent, and thus there is the possibility of overheating and fire when a short circuit occurs. In this regard, all-solid-state batteries using a solid electrolyte instead of an electrolyte have been proposed.

Since all-solid-state batteries do not use a flammable organic solvent, even when a short circuit occurs, the possibility of fires or explosions may be considerably reduced. Therefore, such all-solid-state batteries may considerably increase safety as compared with lithium ion batteries that use an electrolyte.

Related art 1: Japanese Patent Publication No. 2011-081915 discloses a composite solid electrolyte including a sulfide-based solid electrolyte and oxide-based solid electrolyte particles as spacer particles, but lithium ion conductivity is low.

Related art 2: Japanese Patent Publication No. 2009-158476 discloses a sulfide-based solid electrolyte including alumina disposed in sulfide-based solid electrolyte particles, but preparation thereof is not easy because high-temperature heat treatment is required.

### DISCLOSURE

### Technical Problem

An aspect provides a novel all-solid-state secondary battery.

Another aspect provides a method of manufacturing an all-solid-state secondary battery.

### Technical Solution

According to an embodiment, there is provided an all-solid-state secondary battery including a cathode layer, an anode layer, and a solid electrolyte layer disposed between the cathode layer and the anode layer, wherein the solid electrolyte layer includes a sulfide-based solid electrolyte and inorganic particles, wherein the inorganic particles have an average particle diameter of 50 nm to 5 μm or less.

According to another embodiment, there is provided a method of manufacturing an all-solid-state secondary battery including dry-mixing a sulfide-based solid electrolyte, inorganic particles, and a binder to prepare a dry mixture, molding the dry mixture to prepare a solid electrolyte layer, and arranging the solid electrolyte layer between a cathode layer and an anode layer, wherein the inorganic particles have an average particle diameter of 50 nm to 5 μm or less.

### Advantageous Effects

According to an aspect, according to an all-solid-state secondary battery, there may be provided an all-solid-state secondary battery in which a short circuit is prevented and which has improved discharge capacity and lifespan characteristics.

### DESCRIPTION OF DRAWINGS

FIG. 1 is a cross-sectional view of an all-solid-state secondary battery according to an exemplary embodiment.

FIG. 2 is a cross-sectional view of a bi-cell all-solid-state secondary battery according to an exemplary embodiment.

FIG. 3 is a cross-sectional view of an all-solid-state secondary battery according to an exemplary embodiment.

FIG. 4 is a cross-sectional view of a bi-cell all-solid-state secondary battery according to an exemplary embodiment.

FIG. 5 is a cross-sectional view of an all-solid-state secondary battery structure according to an exemplary embodiment.

FIG. 6 is a cross-sectional view of an all-solid-state secondary battery structure according to an exemplary embodiment.

FIG. 7 is a cross-sectional view of an all-solid-state secondary battery structure according to an exemplary embodiment.

FIG. 8 is a cross-sectional view of an all-solid-state secondary battery structure according to an exemplary embodiment.

### BEST MODE

Since an electrolyte of an all-solid-state secondary battery is solid, when contact between a cathode layer and a solid electrolyte layer and contact between an anode layer and the solid electrolyte layer are not sufficiently maintained, the resistance in the battery increases, which makes it difficult to exhibit excellent battery characteristics.

In order to increase contact between an anode layer and a solid electrolyte, a pressing process is performed during a process of manufacturing an all-solid-state secondary battery. When uniform pressure is not applied to a solid electrolyte layer during a pressing process, a pressure difference occurs, and fur to the pressure difference, micro-defects are caused in the solid electrolyte layer. During a charging or discharging process of an all-solid-state secondary battery, cracks occur and grow in a solid electrolyte layer from such defects. As lithium grows through such cracks, a short circuit occurs between a cathode layer and an anode layer, or as such cracks increase, the internal resistance of an all-solid-state secondary battery increases, thereby deteriorating the cycle characteristics of the all-solid-state secondary battery.

According to an aspect, an all-solid-state secondary battery has a new configuration so that a short circuit is prevented during charging or discharging and cycle characteristics are improved.

Hereinafter, as the present inventive concept allows for various changes and numerous embodiments, specific embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe specific embodiments and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification and are not intended to preclude the possibility that one or more other features, numbers, steps, actions, components, parts, ingredients, materials, or combinations thereof may exist or may be added. The symbol “/” used herein may be interpreted as “and” or “or” according to the context.

In the drawings, the thicknesses of layers and regions are exaggerated or reduced for clarity. Like reference numerals in the drawings denote like elements throughout the specification. Throughout the specification, it will be understood that when a component, such as a layer, a film, a region, or a plate, is referred to as being “on” another component, the component may be directly on the other component or intervening components may be present thereon. Throughout the specification, while such terms as “first,” “second,” and the like may be used to describe various components, such components should not be limited to the above terms. The above terms are used only to distinguish one component from another. Components having substantially the same functional configuration in the present specification and drawings are denoted by the same reference numerals, and redundant descriptions thereof will be omitted.

As used herein, an “average particle diameter” is measured by using a laser scattering particle size distribution meter (for example, LA-920 manufactured by Horiba Corporation) and is a value of a median diameter (D50) when metal oxide particles are accumulated to 50% from smaller particles in volume conversion. Alternatively, as used herein, “average particle diameter” is measured manually or by software from a scanning electron microscope and/or transmission electron microscope image of a cross section of an all-solid-state secondary battery and is calculated an arithmetic average value of particle diameters of a plurality of particles shown in the image.

Hereinafter, an all-solid-state secondary battery according to exemplary embodiments will be described in more detail.

### All-Solid-State Secondary Battery

An all-solid-state secondary battery according to an embodiment includes a cathode layer, an anode layer, and a solid electrolyte layer disposed between the cathode layer and the anode layer, wherein the solid electrolyte layer includes a sulfide-based solid electrolyte and inorganic particles, wherein the inorganic particles have an average particle diameter of 50 nm to 5 μm or less. Since the solid electrolyte layer includes the inorganic particles having an average particle diameter in such a range, defects in the solid electrolyte layer that occur during pressing and charging/discharging of the all-solid-state secondary battery are suppressed, and cracks of the solid electrolyte layer caused by the defects are suppressed, thereby suppressing a short circuit of the all-solid-state secondary battery. In addition, since an increase in internal resistance of the all-solid-state secondary battery is suppressed, a discharge capacity during charging or discharging is increased, and thus the cycle characteristics of the all-solid-state secondary battery are improved.

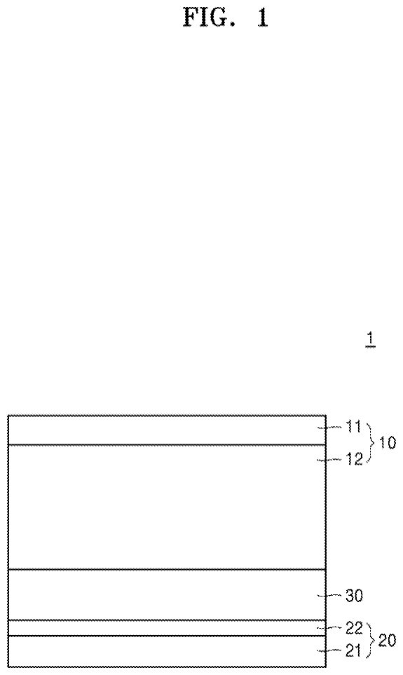

Referring to FIGS. 1 to 4, an all-solid-state secondary battery 1 includes a cathode layer 10, an anode layer 20, and a solid electrolyte layer 30 disposed between the cathode layer 10 and the anode layer 20, wherein the solid electrolyte layer 30 includes a sulfide-based solid electrolyte and inorganic particles, wherein the inorganic particles have an average particle diameter of 50 nm to 5 μm or less.

### Solid Electrolyte Layer

### [Solid Electrolyte Layer: Inorganic Particles]

Referring to FIGS. 1 to 4, the solid electrolyte layer 30 is disposed between the cathode layer 10 and the anode layer 20. The solid electrolyte layer 30 includes the sulfide-based solid electrolyte and the inorganic particles, and the inorganic particles have an average particle diameter of 50 nm to 5 μm. The average particle diameter of the inorganic particles may be, for example, in a range of 100 nm to 5 μm, 100 nm to 3 μm, or 100 nm to 2 μm.

When the average particle diameter of the inorganic particles is excessively large, a non-uniform distribution of the inorganic particles may be obtained in the solid electrolyte layer. In this case, a region with low ionic conductivity is formed in a region in which a content of the inorganic particles is high, thereby increasing the internal resistance of the solid electrolyte layer 30 and deteriorating the cycle characteristics of the all-solid-state secondary battery 1. When the average particle diameter of the inorganic particles is excessively small, a uniform dispersion in the solid electrolyte layer 30 may be difficult. In addition, a plurality of inorganic particles aggregate to form secondary particles, which may cause the same disadvantages as a case in which inorganic particles with a substantially large average particle diameter are used in the solid electrolyte layer 30. A Young's modulus of the inorganic particles included in the solid electrolyte layer 30 may be higher than that of, for example, the sulfide-based solid electrolyte. When the inorganic particles have a higher Young's modulus than the sulfide-based solid electrolyte, during pressing of the solid electrolyte layer 30, a higher pressure is applied to the solid electrolyte layer 30 as compared with when there are no inorganic particles, thereby further improving the strength and elasticity of the solid electrolyte layer 30. Therefore, the possibility of the occurrence of defects inside the solid electrolyte layer 30 may be further suppressed when the solid electrolyte layer 30 is pressed. A difference between the Young's modulus of the inorganic particles and the Young's modulus of the sulfide-based solid electrolyte may be, for example, 50 GPa or more, 100 GPa or more, or 200 GPa or more. The Young's modulus of the inorganic particles may be, for example, in a range of 50 GPa to 1,000 GPa, 50 GPa to 500 GPa, or 90 GPa to 400 GPa. The Young's modulus of the sulfide-based solid electrolyte may be, for example, 40 GPa or less. The Young's modulus of the sulfide-based solid electrolyte may be, for example, in a range of 5 GPa to 40 GPa, 10 GPa to 40 GPa, or 15 GPa to 30 GPa.

The inorganic particles included in the solid electrolyte layer 30 may be inert with respect to, for example, the sulfide-based solid electrolyte. Therefore, even when the solid electrolyte layer 30 includes the inorganic particles, side reactions between the sulfide-based solid electrolyte and the inorganic particles may be prevented during a charging or discharging process of the all-solid-state secondary battery. On the other hand, when the solid electrolyte layer 30 includes inorganic particles that are active toward the sulfide-based solid electrolyte like a lithium transition metal oxide, the sulfide-based solid electrolyte reacts with the lithium transition metal oxide during a charging or discharging process of the all-solid-state secondary battery 1 to be decomposed and/or denatured into a compound without lithium ion conductivity, which abruptly increases the internal resistance of the solid electrolyte layer 30. As a result, the all-solid-state secondary battery 1 may rapidly deteriorate.

For example, the inorganic particles included in the solid electrolyte layer 30 may be free of lithium ion conductivity. The inorganic particles do not have lithium ion conductivity and thus may be electrochemically stable during a charging or discharging process of the all-solid-state secondary battery 1. Therefore, the inorganic particles included in the solid electrolyte layer 30 may be distinguished from an oxide-based solid electrolyte of a related art having lithium ion conductivity.

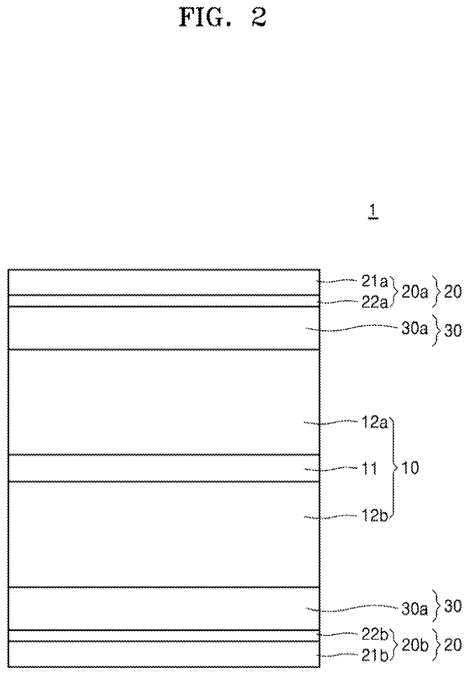

Related art 1 discloses a composite solid electrolyte including a sulfide-based solid electrolyte and an oxide-based solid electrolyte having lithium ion conductivity as a spacer. As shown in FIG. 2 of related art 1, since the composite solid electrolyte includes the oxide-based solid electrolyte as the spacer, the lithium ion conductivity of the composite solid electrolyte decreases abruptly as compared with a sulfide-based solid electrolyte that does not include an oxide-based solid electrolyte. Therefore, the cycle characteristics of an all-solid-state secondary battery including such a composite solid electrolyte are deteriorated as compared with the cycle characteristics of an all-solid-state secondary battery including only a sulfide-based solid electrolyte. On the other hand, the all-solid-state secondary battery 1 including the solid electrolyte layer 30 of the present disclosure includes the solid electrolyte layer 30 including the inorganic particles free of lithium ion conductivity, and thus cycle characteristics are actually improved as compared with a sulfide-based solid electrolyte that does not includes such inorganic particles. For example, Table 1 in Evaluation Example 1 of the present specification is referred. During a process of preparing the solid electrolyte layer, the inorganic particles free of lithium ion conductivity may serve as, for example, a lubricant between sulfide-based solid electrolyte particles, and thus the cycle characteristics of the all-solid-state secondary battery 1 may be improved. In a process of pressing a mixture including sulfide-based solid electrolyte particles and inorganic particles, the inorganic particles serve as a lubricant between the sulfide-based solid electrolyte particles, thereby reducing a local imbalance of pressure that occurs between the sulfide-based solid electrolyte particles. As a result, the occurrence of defects inside the solid electrolyte layer due to the local imbalance of pressure may be effectively suppressed. In addition, the inorganic particles free of lithium ion conductivity may have a particle diameter in a certain range and/or a particle diameter ratio with the sulfide-based solid electrolyte particles and thus may more effectively serve as the above-described lubricant. The particle diameter ratio of the inorganic particles free of lithium ion conductivity to the sulfide-based solid electrolyte particles is as defined in the part of the sulfide-based solid electrolyte below.

The inorganic particles included in the solid electrolyte layer 30 may include, for example, a metal oxide. The inorganic particles may include, for example, a binary metal oxide including one type of metal element and an oxygen atom. The inorganic particles may include, for example, a binary metal oxide represented by AₓO_{y}, wherein 0<x≤3 and 0<y≤5. The inorganic particles may include, for example, at least one selected from MgO, SiO₂, Al₂O₃, TiO₂, Ti₂O₃, ZrO₂, ZnO, B₂O, B₂O₃, Ga₂O₃, TeO, TeO₃, Cs₂O, SnO, SnO₂, CrO₃, Cr₂O₃, BeO, FeO, Fe₂O₃, BaO, PbO, PbO₂, Pb₂O₃, and Pb₃O₄.

A content of the inorganic particles included in the solid electrolyte layer 30 may be in a range of 1 wt % to 10 wt %, 2 wt % to 8 wt %, or 3 wt % to 7 wt % with respect to the total weight of the solid electrolyte layer. Since the solid electrolyte layer 30 includes the inorganic particles in such a range, the cycle characteristics of the all-solid-state secondary battery may be further improved. When the content of inorganic particles is excessively low, it may be difficult to achieve an effect obtained by adding inorganic particles. When the content of inorganic particles is excessively high, due to an increase in internal resistance of the solid electrolyte layer 30, the cycle characteristics of the all-solid-state secondary battery 1 may deteriorate.

### [Solid Electrolyte Layer: Sulfide-Based Solid Electrolyte]

The solid electrolyte layer 30 may include the sulfide-based solid electrolyte, and the sulfide-based solid electrolyte may include a plurality of sulfide-based solid electrolyte particles. The inorganic particles included in the solid electrolyte layer 30 may be disposed between the plurality of sulfide-based solid electrolyte particles. For example, interstitial pores may be formed between the plurality of sulfide-based solid electrolyte particles, and the inorganic particles may be disposed in the pores. During a process of manufacturing an all-solid-state secondary battery 1, the solid electrolyte layer 30 may be pressed to reduce a volume of the pores formed between the sulfide-based solid electrolyte particles, and as a result, the inorganic particles may be disposed between the sulfide-based solid electrolyte particles. For example, the inorganic particles may be disposed in interstitial pores between three or more sulfide-based solid electrolyte particles and/or at grain boundaries between two or more sulfide-based solid electrolyte particles. The inorganic particles may be disposed between the plurality of sulfide-based solid electrolyte particles included in the solid electrolyte layer 30 so that the strength and elasticity of the solid electrolyte layer 30 may be further improved, and internal defects may be further reduced. As a result, the occurrence of cracks and short circuits in the solid electrolyte layer 30 may be more effectively suppressed.

In related art 2, sulfide-based solid electrolyte glass including alumina is pulverized to prepare sulfide-based solid electrolyte particles including alumina. Next, the prepared sulfide-based solid electrolyte particles are pressed to prepare a solid electrolyte layer. Therefore, in the solid electrolyte layer of related art 1, alumina is not disposed in pores and/or grain boundaries between the sulfide-based solid electrolyte particles and is disposed inside the sulfide-based solid electrolyte particles. Therefore, it is difficult for alumina particles of related art 2 to suppress the occurrence of defects inside the solid electrolyte layer due to a local imbalance in pressure occurring between the sulfide-based solid electrolyte particles formed during a process of preparing the solid electrolyte layer.

On the other hand, in the solid electrolyte layer 30 of the present disclosure, as described above, since the inorganic particles are disposed in the pores between the sulfide-based solid electrolyte particles, when the sulfide-based solid electrolyte particles are pressed, a local imbalance in pressure applied to the sulfide-based solid electrolyte particles may be effectively offset, thereby suppressing the occurrence of defects inside the solid electrolyte layer 30. In addition, the inorganic particles may have a particle diameter in a certain range and/or a particle diameter ratio in a certain range with the sulfide-based solid electrolyte particles so that the occurrence of defects in the solid electrolyte layer 30 may be more effectively suppressed.

An average particle diameter of the sulfide-based solid electrolyte particles included in the solid electrolyte layer 30 may be, for example, in a range of 1 μm to 50 μm, 3 μm to 30 μm, or 3 μm to 20 μm. Since the sulfide-based solid electrolyte particles have an average particle diameter in such a range, the cycle characteristics of the all-solid-state secondary battery 1 may be further improved. When the average particle diameter of the sulfide-based solid electrolyte particles excessively increases, since a volume of pores therebetween increases, the energy density of the all-solid-state secondary battery 1 may decrease. When the average particle diameter of the sulfide-based solid electrolyte particles excessively decreases, it may not be easy to prepare the solid electrolyte layer 30.

A particle diameter ratio of the average particle diameter of the sulfide-based solid electrolyte particles to the average particle diameter of the inorganic particles included in the solid electrolyte layer 30 may be, for example, in a range of 1:2 to 1:200 or 1:2 to 1:100. Since the inorganic particles and the sulfide-based solid electrolyte particles have a particle diameter ratio in such a range, the cycle characteristics of the all-solid-state secondary battery may be further improved. Since the inorganic particles and the sulfide-based solid electrolyte particles have a particle diameter ratio in such a range, the inorganic particles may more effectively serve as a lubricant during a process of preparing the solid electrolyte layer 30, thereby further suppressing the occurrence of defects inside the solid electrolyte layer 30. As a result, the occurrence and/or growth of cracks induced by the defects may be prevented during a charging or discharging process of the all-solid-state secondary battery including the solid electrolyte layer 30.

The sulfide-based solid electrolyte included in the solid electrolyte layer 30 includes, for example, at least one selected from Li₂S-P₂S₅, Li₂S-P₂S₅-LiX, wherein X is a halogen element, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ, wherein m and n are each a positive number and Z is one of Ge, Zn, and Ga, Li₂S-GeS₂, Li₂S-SiS₂-Li₃PO₄, Li₂S-SiS₂-LiₚMO_{q}, wherein p and q are each a positive number and M is one of P, Si, Ge, B, Al, Ga, and In, Li₃PS₄, Li₇P₃S₁₁, Li₇₋ₓPS₆₋ₓClₓ, wherein 0≤x≤2, Li₇₋ₓPS_{6-xBr}ₓ, wherein 0≤x≤2, and Li₇₋ₓPS_{6-xI}ₓ, wherein 0≤x≤2. For example, the sulfide-based solid electrolyte is prepared by treating a starting material such as Li₂S or P₂S₅ through melt quenching or mechanical milling. In addition, after such treating, heat treatment may be performed. A solid electrolyte may be in an amorphous state, a crystalline state, or a mixture state thereof. In addition, the solid electrolyte may be, for example, a material that includes at least sulfur(S), phosphorus (P), and lithium (Li) as constituent elements among the above-described materials of the sulfide-based solid electrolyte. For example, the solid electrolyte may be a material including Li₂S-P₂S₅. When a material including Li₂S-P₂S₅ is used as a sulfide-based solid electrolyte material for forming a solid electrolyte, a mixing molar ratio of Li₂S to P₂S₅, for example, Li₂S:P₂S₅ may be in a range of about 50:50 to about 90:10. The sulfide-based solid electrolyte may include, for example, an argyrodite-type solid electrolyte represented by Formula 1 below:

Li⁺₁₂₋ₙ₋ₓAⁿ⁺X²⁻₆₋ₓY⁻ₓ <Formula 1>

In Formula 1, A is P, As, Ge, Ga, Sb, Si, Sn, Al, In, Ti, V, Nb, or Ta, X is S, Se, or Te, Y is Cl, Br, I, F, CN, OCN, SCN, or N₃, 1≤n(≤5, and 0≤x≤2. The sulfide-based solid electrolyte may be, for example, an argyrodite-type compound including at least one selected from Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ. wherein 0≤x≤2. The sulfide-based solid electrolyte may be, for example, an argyrodite-type compound including at least one selected from Li₆PS₅Cl, Li₆PS₅Br, and Li₆PS₅I.

The argyrodite-type solid electrolyte may have a density of 1.5 g/cc to 2.0 g/cc. The argyrodite-type solid electrolyte may have a density of 1.5 g/cc or more so that the internal resistance of the all-solid-state secondary battery may be reduced and Li may be effectively suppressed from penetrating the solid electrolyte layer.

### [Solid Electrolyte Layer: Binder]

The solid electrolyte layer 30 may further include, for example, a binder. The binder included in the solid electrolyte layer 30 may include, for example, styrene-butadiene rubber (SBR), polytetrafluoroethylene, polyvinylidene fluoride, polyethylene, or the like, but one or more embodiments are not limited thereto. Any material may be used as long as the material is used as a binder in the art. The binder of the electrolyte layer 30 may be the same as or different from a binder included in a cathode active material layer 12 and an anode active material layer 22. The binder may be omitted.

The binder included in the solid electrolyte layer 30 may include, for example, a conductive binder and/or a non-conductive binder.

The conductive binder may include, for example, an ion-conductive binder and/or an electron-conductive binder. A binder having both ionic conductivity and electronic conductivity may belong to an ion-conductive binder and may also belong to an electron-conductive binder.

The ion-conductive binder includes, for example, polytetrafluoroethylene (PTFE), polyvinylidene fluoride (PVDF), polystyrene sulfonate (PSS), a polyvinylidene fluoride-hexafluoropropylene (PVDF-HFP) copolymer, polyvinyl fluoride (PVF), poly(methylmethacrylate) (PMMA), polyethylene oxide (PEO), polyethylene glycol (PEG), polyacrylonitrile (PAN), polyethylenedioxythiophene (PEDOT), polypyrrole (PPY), polyaniline, and polyacetylene. The ion-conductive binder may include a polar functional group. Examples of the ion-conductive binder including the polar functional group include NAFION™ AQUIVION®, FLEMION®, GORE™, ACIPLEX™, MORGANE®-ADP, sulfonated poly(ether ether ketone) (SPEEK), sulfonated poly(arylene ether ketone ketone sulfone) (SPAEKKS), sulfonated poly(sulfonated poly(aryl ether ketone) (SPAEK), poly[bis(benzimidazobenzisoquinolinones)] (SPBIBI), poly(styrene sulfonate) (PSS), lithium 9,10-diphenylanthracene-2-sulfonate (DPASLi⁺), and the like. Examples of the electron-conductive binder include polyacetylene, polythiophene, PPY, poly(p-phenylene), poly(phenylenevinylene), poly(phenylenesulfide), polyaniline, and the like.

The binder included in the solid electrolyte layer 30 may include, for example, a first binder. The first binder is, for example, a dry binder. The dry binder is, for example, a binder that is not impregnated, dissolved, or dispersed in a solvent. The dry binder is, for example, a binder that does not include or come into contact with a solvent.

The first binder is, for example, a fibrillized binder. The fibrillized binder may serve as a matrix in the form of fiber that supports the plurality of sulfide-based solid electrolyte particles and the inorganic particles included in the solid electrolyte layer 30 and binds the sulfide-based solid electrolyte particles and the inorganic particles to each other. For example, it may be confirmed from a scanning electron microscope image of an electrode cross section that the fibrillized binder has a fibrous form. The fibrillized binder may have an aspect ratio of, for example, 10 or more, 20 or more, 50 or more, or 100 or more. The first binder may include, for example, PTFE, a PVDF-HFP copolymer, or the like, but one or more embodiments are not necessarily limited thereto. Any fibrillized binder may be used as long as the fibrillized binder is used to prepare a dry composition. The first binder may particularly include a fluorine-based binder. The fluorine-based binder includes, for example, PTFE.

The binder included in the solid electrolyte layer 30 may further include, for example, a second binder. The second binder is, for example, a dry binder. The description of the dry binder is the same as the description of the first binder.

The second binder is, for example, a non-fibrillized binder. The non-fibrillized binder may serve as a binding site that supports the sulfide-based solid electrolyte particles and the inorganic particles included in the solid electrolyte layer 30 and binds the sulfide-based solid electrolyte particles and the inorganic particles to each other. For example, it may be confirmed from a scanning electron microscope image of an electrode cross section that the non-fibrillized binder does not have a fibrous form and is disposed in a particulate form. The non-fibrillized binder may have an aspect ratio of, for example, 5 or less, 3 or less, or 2 or less. The second binder may include, for example, PVDF, polyvinyl alcohol, PAN, carboxymethylcellulose (CMC), starch, hydroxypropylcellulose, cellulose, polyvinylpyrrolidone, polyethylene, a polypropylene, ethylene-propylene-diene polymer (EPDM), a sulfonated-EPDM, SBR, fluororubber, or a copolymer thereof, but one or more embodiments are not necessarily limited thereto. An dry binder may be used as long as the dry binder is used to prepare a dry electrode. The second binder may particularly include a fluorine-based binder. The fluorine-based binder includes, for example, PVDF.

A content of the binder included in the solid electrolyte layer 30 is, for example, in a range of 1 wt % to 10 wt %, 1 wt % to 5 wt %, or 1 wt % to 3 wt % with respect to the total weight of the solid electrolyte layer. Since the solid electrolyte layer 30 includes the binder in such a content range, a binding force of the solid electrolyte layer 30 may be improved, and the all-solid-state secondary battery 1 may maintain high energy density.

The solid electrolyte layer 30 is, for example, a self-standing film. For example, the solid electrolyte layer 30 may maintain the form of a film without a support. Therefore, the solid electrolyte layer 30 may be prepared as a separate self-standing film and then may be disposed the cathode layer 10 and the anode layer 20. For example, the solid electrolyte layer 30 may be free of a residual process solvent. For example, since the solid electrolyte layer 30 is prepared as a dry type, the solid electrolyte layer 30 does not include an intentionally added process solvent. For example, the solid electrode layer 30 may not include a residual process solvent. An unintentional trace amount of solvent may remain in the solid electrode layer 30, but the solvent is not an intentionally added process solvent. Therefore, the solid electrolyte layer 30 is distinguished from a wet solid electrolyte layer prepared by mixing sulfide-based solid electrolyte particles and a process solvent and then removing a portion or the entirety of the process solvent through drying.

### Anode Layer

### [Anode Layer: Anode Active Material]

Referring to FIGS. 1 to 4, the anode layer 20 includes an anode current collector 21, and a first anode active material layer 22 disposed on the anode current collector 21. The first anode active material layer 22 includes, for example, an anode active material and a binder.

The anode active material included in the first anode active material layer 22 has, for example, a particle form. An average particle diameter of the anode active material having the particle form is, for example, 4 μm or less, 3 μm or less, 2 μm or less, 1 μm or less, or 900 nm or less. The average particle diameter of the anode active material having the particle form is, for example, in a range of 10 nm to 4 μm or less, 10 nm to 3 μm or less, 10 nm to 2 μm or less, 10 nm to 1 μm or less, or 10 nm to 900 nm or less. The anode active material may have an average particle diameter in such a range, and thus the reversible absorbing and/or desorbing of lithium may become easier during charging or discharging. The average particle diameter of the anode active material is, for example, a median diameter (D50) measured by using a laser type particle size distribution meter.

The anode active material included in the first anode active material layer 22 includes, for example, at least one selected from a carbon-based anode active material and a metal or metalloid anode active material.

The carbon-based anode active material may be, in particular, amorphous carbon. Examples of the amorphous carbon include carbon black (CB), acetylene black (AB), furnace black (FB), Ketjen black (KB), graphene, and the like, but one or more embodiments are not necessarily limited thereto. Any material may be used as long as the material is classified as amorphous carbon in the art. The amorphous carbon is carbon that has no crystallinity or very low crystallinity and is distinguished from crystalline carbon or graphite-based carbon.

The metal or metalloid anode active material includes at least one selected from the group consisting of gold (Au), platinum (Pt), palladium (Pd), silicon (Si), silver (Ag), aluminum (Al), bismuth (Bi), tin (Sn), and zinc (Zn), but one or more embodiments are not necessarily limited thereto. Any material may be used as long as the material is used as a metal anode active material or a metalloid anode active material which forms an alloy or compound with lithium in the art. For example, nickel (Ni) does not form an alloy with lithium and thus is not a metal anode active material.

The first anode active material layer 22 includes one type of anode active material among such anode active materials or a mixture of a plurality of different anode active materials. For example, the first anode active material layer 22 includes only amorphous carbon or includes at least one selected the group consisting of gold (Au), platinum (Pt), palladium (Pd), silicon (Si), silver (Ag), aluminum (Al), bismuth (Bi), tin (Sn), and zinc (Zn). Alternatively, the first anode active material layer 22 includes a mixture of amorphous carbon and at least one selected from the group consisting of gold (Au), platinum (Pt), palladium (Pd), silicon (Si), silver (Ag), aluminum (Al), bismuth (Bi), tin (Sn), and zinc (Zn). A mixing ratio of the mixture of amorphous carbon to gold or the like is, for example, a weight ratio in a range of 10:1 to 1:2, 5:1 to 1:1, or 4:1 to 2:1, but one or more embodiments are not necessarily limited to such a range. The mixing ratio may be selected according to the required characteristics of the all-solid-state secondary battery 1. The anode active material has such a composition, and thus the cycle characteristics of the all-solid-state secondary battery 1 are further improved.

The anode active material included in the first anode active material layer 22 includes, for example, a mixture of first particles consisting of amorphous carbon and second particles consisting of a metal or metalloid. Examples of the metal or metalloid includes gold (Au), platinum (Pt), palladium (Pd), silicon (Si), silver (Ag), aluminum (Al), bismuth (Bi), tin (Sn), zinc (Zn), and the like. Alternatively, the metalloid is a semiconductor. A content of the second particles is in a range of 8 wt % to 60 wt %, 10 wt % to 50 wt %, 15 wt % to 40 wt %, or 20 wt % to 30 wt % with respect to the total weight of the mixture. The second particles have a content in such a range, and thus, for example, the cycle characteristics of the all-solid-state secondary battery 1 are further improved.

### [Anode Layer: Binder]

The binder included in the first anode active material layer 22 is, for example, SBR, PTFE, PVDF, PE, a vinylidene fluoride/hexafluoropropylene copolymer, PAN, polymethyl methacrylate, or the like, but one or more embodiments are not necessarily limited thereto. Any material may be used as long as the material is used as a binder in the art. The binder may be provided as a single binder or a plurality of different binders.

The first anode active material layer 22 includes the binder and thus is stabilized on the anode current collector 21. In addition, cracks of the first anode active material layer 22 are suppressed despite changes in volume and/or relative position of the first anode active material layer 22 during a charging or discharging process. For example, when the first anode active material layer 22 does not include a binder, the first anode active material layer 22 may be easily separated from the anode current collector 21. At a portion of the anode current collector 21 exposed due to the separation of the first anode active material layer 22 from the anode current collector 21, the anode current collector 21 is in contact with the solid electrolyte layer 30, which increases the possibility of the occurrence of a short circuit. The first anode active material layer 22 is formed, for example, by applying a slurry, in which a material constituting the first anode active material layer 22 is dispersed, onto the anode current collector 21 and drying the slurry. The first anode active material layer 22 may include the binder, and thus an anode active material may be stably distributed in the slurry. For example, when the slurry is applied onto the anode current collector 21 through screen printing, the clogging of a screen (for example, clogging by aggregates of an anode active material) may be suppressed.

### [Anode Layer: Other Additives]

The first anode active material layer 22 may further include additives used in the all-solid- state secondary battery 1 according to a related art, such as a filler, a coating agent, a dispersant, and an ion-conductive adjuvant.

### [Anode Layer: First Anode Active Material Layer]

A thickness of the first anode active material layer 22 is, for example, 50% or less, 40% or less, 30% or less, 20% or less, 10% or less, or 5% or less of a thickness of the cathode active material layer 12. The thickness of the first anode active material layer 22 is, for example, in a range of 1 μm to 20 μm, 2 μm to 10 μm, or 3 μm to 7 μm. When the first anode active material layer 22 is excessively thin, lithium dendrites formed between the first anode active material layer 22 and the anode current collector 21 collapse the first anode active material layer 22, which makes it difficult to improve the cycle characteristics of the all-solid-state secondary battery 1. When the thickness of the first anode active material layer 22 excessively increases, the energy density of the all-solid-state secondary battery 1 decreases, and the internal resistance of the all-solid-state secondary battery 1 due to the first anode active material layer 22 increases, which makes it difficult to improve the cycle characteristics of the all-solid-state secondary battery 1.

When the thickness of the first anode active material layer 22 decreases, for example, a charge capacity of the first anode active material layer 22 also decreases. For example, the charge capacity of the first anode active material layer 22 is 50% or less, 40% or less, 30% or less, 20% or less, 10% or less, 5% or less, or 2% or less of a charge capacity of the cathode active material layer 12. The charge capacity of the first anode active material layer 22 is, for example, in a range of 0.1% to 50%, 0.1% to 40%, 0.1% to 30%, 0.1% to 20%, 0.1% to 10%, 0.1% to 5%, or 0.1% to 2% of the charge capacity of the cathode active material layer 12. When the charge capacity of the first anode active material layer 22 is excessively low, the first anode active material layer 22 becomes very thin, and thus, during a repeated charging or discharging process, lithium dendrites formed between the first anode active material layer 22 and the anode current collector 21 collapse the first anode active material layer 22, which makes it difficult to improve the cycle characteristics of the all-solid-state secondary battery 1. When the charge capacity of the first anode active material layer 22 excessively increases, the energy density of the all-solid-state secondary battery 1 decreases, and the internal resistance of the all-solid-state secondary battery 1 due to the first anode active material layer 22 increases, which makes it difficult to improve the cycle characteristics of the all-solid-state secondary battery 1.

The charge capacity of the cathode active material layer 12 is obtained by multiplying a specific charge capacity (mAh/g) of a cathode active material by a mass of the cathode active material in the cathode active material layer 12. When various types of cathode active materials are used, a value of specific charge capacity×mass is calculated for each cathode active material, and the sum of the values is the charge capacity of the cathode active material layer 12. The charge capacity of the first anode active material layer 22 is also calculated in the same manner. That is, the charge capacity of the first anode active material layer 22 is obtained by multiplying a specific charge capacity (mAh/g) of an anode active material by a mass of the anode active material in the first anode active material layer 22. When various types of anode active materials are used, a value of specific charge capacity×mass is calculated for each anode active material, and the sum of the values is the charge capacity of the first anode active material layer 22. Here, the specific charge capacities of the cathode active material and the anode active material are capacities estimated by using an all-solid-state half-cell using a lithium metal as a counter electrode. The charge capacities of the cathode active material layer 12 and the first anode active material layer 22 is directly measured by measuring charge capacity by using an all-solid-state half-cell. When the measured charge capacity is divided by a mass of each active material, a specific charge capacity is obtained. Alternatively, the charge capacities of the cathode active material layer 12 and the anode active material layer 22 may be initial charge capacities measured during a 1^{st} cycle of charging.

### [Anode Layer: Second Anode Active Material Layer]

Although not shown in the drawings, the all-solid-state secondary battery 1 further includes a second anode active material layer which, through charging, is disposed between the anode current collector 21 and the first anode active material layer 22. The second anode active material layer is a metal layer including lithium or a lithium alloy. The metal layer includes lithium or the lithium alloy. Therefore, the second anode active material layer is the metal layer including lithium and thus serves, for example, as a lithium reservoir. Examples of the lithium alloy include a Li-Al alloy, a Li-Sn alloy, a Li-In alloy, a Li-Ag alloy, a Li-Au alloy, a Li-Zn alloy, a Li-Ge alloy, a Li-Si alloy, and the like, but one or more embodiments are not limited thereto. Any material may be used as long as the material is used as a lithium alloy in the art. The second anode active material layer may consist of one of such alloys or lithium or may consist of various types of alloys. The second anode active material layer is, for example, a plated layer. For example, the second anode active material layer is precipitated between the first anode active material layer 22 and the anode current collector 21 during a charging process of the all-solid-state secondary battery 1.

A thickness of the second anode active material layer is not particularly limited, but may be, for example, in a range of 1 μm to 1,000 μm, 1 μm to 500 μm, 1 μm to 200 μm, 1 μm to 150 μm, 1 μm to 100 μm, or 1 μm to 50 μm. When the second anode active material layer is excessively thin, it is difficult for the second anode active material layer to function as a lithium reservoir. When the second anode active material layer is excessively thick, the mass and volume of the all- solid-state secondary battery 1 may increase, and the cycle characteristics thereof may actually deteriorate. The second anode active material layer may be, for example, metal foil having a thickness in such a range.

In the all-solid-state secondary battery 1, the second anode active material layer is, for example, disposed between the anode current collector 21 and the first anode active material layer 22 before the all-solid-state secondary battery 1 is assembled or is precipitated between the anode current collector 21 and the first anode active material layer 22 by the all-solid-state secondary battery 1 being charged after being assembled. When the second anode active material layer is disposed between the anode current collector 21 and the first anode active material layer 22 before the all-solid-state secondary battery 1 is assembled, the second anode active material layer may be the metal layer including lithium and thus may serve as a lithium reservoir. For example, before the all-solid-state secondary battery 1 is assembled, lithium foil is disposed between the anode current collector 21 and the first anode active material layer 22. Thus, the cycle characteristics of the all-solid-state secondary battery 1 including the second anode active material layer are further improved. When the second anode active material layer is precipitated by the all-solid-state secondary battery 1 being charged after being assembled, since the all-solid-state secondary battery 1 does not include the second anode active material layer during the assembly of the all-solid-state secondary battery 1, the energy density of the all-solid-state secondary battery 1 increases. For example, during charging of the all-solid-state secondary battery 1, the first anode active material layer 22 is charged beyond a charge capacity thereof. That is, the first anode active material layer 22 may be overcharged. At the beginning of charging, lithium is adsorbed in the first anode active material layer 22. The anode active material included in the first anode active material layer 22 forms an alloy or compound with lithium ions that move from the cathode layer 10. When charging is performed beyond a capacity of the first anode active material layer 22, for example, lithium is precipitated on a rear side of the first anode active material layer 22, for example, between the anode current collector 21 and the first anode active material layer 22, and a metal layer corresponding to the second anode active material layer is formed by the precipitated lithium. The second anode active material layer is a metal layer mainly consisting of lithium (for example, metallic lithium). Such a result is obtained, for example, because the anode active material included in the first anode active material layer 22 includes a material that forms an alloy or compound with lithium. During discharging, lithium in the first anode active material layer 22 and the second anode active material layer, for example, lithium in the metal layer, is ionized to move toward the cathode layer 10. Therefore, in the all-solid-state secondary battery 1, lithium may be used as an anode active material. In addition, the first anode active material layer 22 covers the second anode active material layer, thereby serving as a protective layer for the second anode active material layer, for example, the metal layer, and simultaneously serving to suppress the precipitation growth of lithium dendrites. Therefore, a short circuit and a reduction in capacity of the all-solid-state secondary battery 1 are suppressed, thereby improving the cycle characteristics of the all-solid-state secondary battery 1. In addition, when the second anode active material layer is disposed by the all-solid-state secondary battery 1 being charged after being assembled, the anode current collector 21, the first anode active material layer 22, and a region therebetween are Li-free regions that do not include lithium (Li) in an initial state of the all-solid-state secondary battery or in a state after discharging thereof.

### [Anode Layer: Anode Current Collector]

The anode current collector 21 consists of a material that does not react with lithium, for example, a material that does not form both an alloy and a compound with lithium. Examples of a material constituting the anode current collector 21 include copper (Cu), stainless steel (SUS), titanium (Ti), iron (Fe), cobalt (Co), and nickel (Ni), but one or more embodiments are not necessarily limited thereto. Any material may be used as long as the material is used as an electrode current collector in the art. The anode current collector 21 may consist of one type of the above-described metals, an alloy of two or more types of metals, or a coating material. The anode current collector 21 is, for example, in the form of a plate or foil.

The all-solid-state secondary battery 1 may further include, for example, a thin film, which includes an element capable of forming an alloy with lithium, on the anode current collector 21. The thin film is disposed between the anode current collector 21 and the first anode active material layer 22. The thin film includes, for example, an element capable of forming an alloy with lithium. Examples of the element capable of forming an alloy with lithium include gold, silver, zinc, tin, indium, silicon, aluminum, bismuth, and the like, but one or more embodiments are not necessarily limited thereto. Any material may be used as long as the material may form an alloy with lithium in the art. The thin film consists of one of such metals or an alloy of various types of metals. The thin film may be disposed on the anode current collector 21 so that, for example, a precipitated form of the second anode active material layer 24 precipitated between the thin film and the first anode active material layer 22 may be further planarized, and the cycle characteristics of the all- solid-state secondary battery 1 may be further improved.

A thickness of the thin film is, for example, in a range of 1 nm to 800 nm, 10 nm to 700 nm, 50 nm to 600 nm, or 100 nm to 500 nm. When the thickness of the thin film is less than 1 nm, it may be difficult for the thin film to function. When the film is excessively thick, the thin film itself may adsorb lithium, and thus an amount of lithium precipitated at an anode 20 may decrease, which may decrease the energy density of the all-solid-state secondary battery 1 and may deteriorate the cycle characteristics of the all-solid-state secondary battery 1. The thin film may be disposed on the anode current collector 21 through, for example, vacuum deposition, sputtering, plating, or the like, but one or more embodiments are not necessarily limited to such a method. Any method capable of forming a thin film in the art may be used.

### Cathode Layer

### [Cathode Layer: Cathode Active Material]

Referring to FIGS. 1 to 4, the cathode active material layer 12 includes, for example, a cathode active material and a solid electrolyte.

The cathode active material included in the cathode active material layer 12 is a cathode active material capable of reversibly absorbing and desorbing lithium ions. Examples of the cathode active material include lithium transition metal oxides such as lithium cobalt oxide (LCO), lithium nickel oxide, lithium nickel cobalt oxide, lithium nickel cobalt aluminum oxide (NCA), lithium nickel cobalt manganate (NCM), lithium manganate, and lithium iron phosphate, nickel sulfide, copper sulfide, lithium sulfide, iron oxide, vanadium oxide, and the like, but one or more embodiments are not necessarily limited thereto. Any material may be used as long as the material is used as a cathode active material in the art. The cathode active materials may each be used alone, or a mixture of two or more types thereof may be used.

The cathode active material includes, for example, a lithium salt of a transition metal oxide having a layered rock salt type structure among the above-described lithium transition metal oxides. The “layered rock salt type structure” is, for example, a structure in which oxygen atomic layers and metal atomic layers are alternately and regularly arranged in a <111> direction of a cubic rock salt type structure, and as a result, each atomic layer forms a two-dimensional plane. The “cubic rock salt structure” refers to a sodium chloride type (NaCl type) structure, which is a type of crystal structure, specifically, a structure in which face centered cubic lattices (FCCs) respectively formed of cations and anions are misarranged by one half a ridge of each unit lattice. The lithium transition metal oxide having such a layered rock salt structure is, for example, a ternary lithium transition metal oxide such as LiNiₓCo_{y}Al_{z}O₂ (NCA), LiNiₓCo_{y}Mn_{z}O₂ (NCM), wherein 0<x<1, 0<y<1, 0<z<1, and x+y+z=1, or the like. When the cathode active material includes a ternary lithium transition metal oxide having a layered rock salt type structure, the energy density and thermal stability of the all-solid-state secondary battery 1 are further improved.

The cathode active material may be covered with a coating layer as described above. As the coating layer, any coating layer may be used as long as the coating layer is known as a coating layer for a cathode active material of an all-solid-state secondary battery. The coating layer includes, for example, Li₂O-ZrO₂ (LZO).

When the cathode active material includes nickel (Ni) as a ternary lithium transition metal oxide such as NCA or NCM, the capacity density of the all-solid-state secondary battery 1 is increased, thereby reducing metal elution from the cathode active material in a charged state. As a result, the cycle characteristics of the all-solid-state secondary battery 1 in a charged state are improved.

The cathode active material may have, for example, a particulate shape such as a spherical shape or an oval shape. A particle diameter of the cathode active material is not particularly limited and may be in a range applicable to a cathode active material of an all-solid-state secondary battery according to a related art. A content of the cathode active material in the cathode layer 10 is also not particularly limited and may be in a range applicable to a cathode layer of an all-solid-state secondary battery according to a related art.

### [Cathode Layer: Solid Electrolyte]

The cathode active material layer 12 may include, for example, a solid electrolyte. The solid electrolyte included in the cathode layer 10 may be the same as or different from the solid electrolyte included in the solid electrolyte layer 30. The solid electrolyte is as defined in the part of the solid electrolyte layer 30.

A D50 average particle diameter of the solid electrolyte included in the cathode active material layer 12 may be less than a D50 average particle diameter of the solid electrolyte included in the solid electrolyte layer 30. For example, the D50 average particle diameter of the solid electrolyte included in the cathode active material layer 12 may be 90% or less, 80% or less, 70% or less, 60%, 50% or less, 40% or less, 30% or less, or 20% or less of the D50 average particle diameter of the solid electrolyte included in the solid electrolyte layer 30.

The D50 average particle diameter is, for example, a median particle diameter (D50). The median particle diameter (D50) is a particle size corresponding to a 50% cumulative volume when a particle size distribution measured through a laser diffraction method is calculated from particles having a smaller particle size.

### [Cathode Layer: Binder]

The cathode active material layer 12 may include a binder. The binder includes, for example, SBR, PTFE, PVDF, polyethylene, or the like, but one or more embodiments are not limited thereto. Any material may be used as long as the material is used as a binder in the art.

### [Cathode Layer: Conductive Material]

The cathode active material layer 12 may include a conductive material. The conductive material includes, for example, graphite, CB, AB, KB, carbon fiber, a metal powder, or the like, but one or more embodiments are not limited thereto. Any material may be used as long as the material is used as a conductive material in the art.

### [Cathode Layer: Other Additives]

In addition to the above-described cathode active material, solid electrolyte, binder, and conductive material, the cathode active material layer 12 may further include, for example, additives such as a filler, a coating agent, a dispersant, and an ion-conductive adjuvant.

As a filler, a coating agent, a dispersant, an ion-conductive adjuvant, and the like that may be included in the cathode active material layer 12, known materials generally used in electrodes of an all-solid-state secondary battery may be used.

### [Cathode Layer: Cathode Current Collector]

A cathode current collector 11 is provided as a plate, foil, or the like consisting of, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted. A thickness of the cathode current collector 11 is, for example, in a range of 1 μm to 100 μm, 1 μm to 50 μm, 5 μm to 25 μm, or 10 μm to 20 μm.

### [Cathode Layer: Inactive Member]

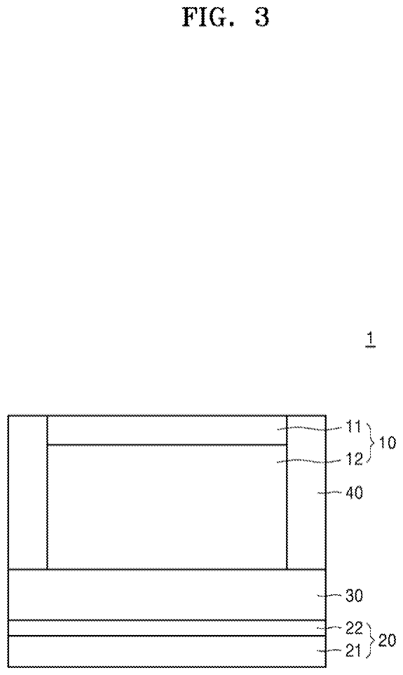

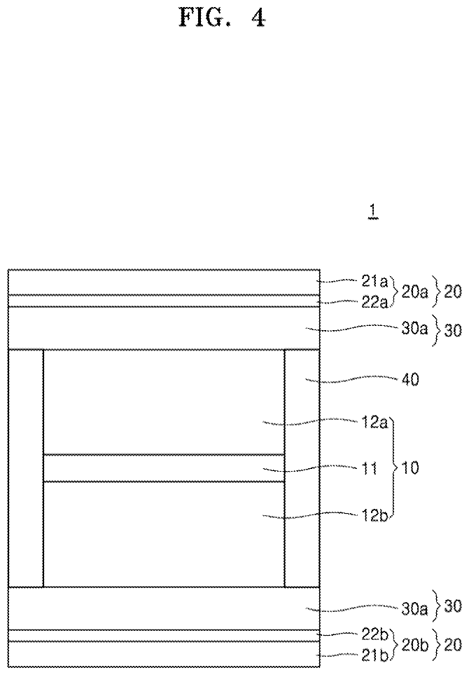

Referring to FIGS. 3 and 4, the cathode layer 10 includes the cathode current collector 11 and the cathode active material layer 12 disposed on one side of the cathode current collector 11. An inactive member 40 is disposed on one side of the cathode layer 10. The inactive member 40 is disposed on one side of each of the cathode active material layer 12 and the cathode current collector 11. Alternatively, although not shown in the drawings, the inactive member 40 may be disposed on one side of the cathode active material layer 12 and may be disposed on one side of the cathode current collector 11 opposite the solid electrolyte layer.

The inactive member 40 is included to prevent cracks of the solid electrolyte layer 30 during manufacturing and/or charging/discharging of the all-solid-state secondary battery 1, thereby improving the cycle characteristics of the all-solid-state secondary battery 1. In the all-solid-state secondary battery 1 that does not include the inactive member 40, a non-uniform pressure may be applied to the solid electrolyte layer 30 in contact with the cathode layer 10 during manufacturing and/or charging/discharging of the all-solid-state secondary battery 1 to cause cracks in the solid electrolyte layer 30, thereby increasing the possibility of the occurrence of a short circuit.

The inactive member 40 surrounds the side of the cathode layer 10 and is in contact with the solid electrolyte layer 30. The inactive member 40 may surround the side of the cathode layer 10 and may be in contact with the solid electrolyte layer 30, thereby effectively suppressing cracks of the solid electrolyte layer 30, which are caused in a portion of the solid electrolyte layer 30, which is not in contact with the cathode layer 10, by a pressure difference during a pressing process. The inactive member 40 surrounds the side of the cathode layer 10 and is separated from the anode layer 20, for example, the first anode active material layer 22. The inactive member 40 surrounds the side of the cathode layer 10, is in contact with the solid electrolyte layer 30, and is separated from the anode layer 20. Therefore, the possibility of a short circuit occurring due to physical contact between the cathode layer 10 and the first anode active material layer 22 or the possibility of a short circuit occurring due to the overcharging of lithium may be suppressed.

The inactive member 40 may be, for example, a gasket. By using the gasket as the inactive member 40, cracks of the solid electrolyte layer 30 caused by a pressure difference during a pressing process may be effectively suppressed.

Referring to FIG. 4, the all-solid-state secondary battery 1 includes the cathode layer 10, the anode layer 20, and the solid electrolyte layer 30 disposed therebetween, wherein the cathode layer 10 includes the cathode current collector 11 and each of a first cathode active material layer 12a and a second cathode active material layer 12b disposed on two sides of the cathode current collector 11, the solid electrode layer 30 includes each of a first solid electrolyte layer 30a in contact with the first cathode active material layer 12a and a second solid electrolyte layer 30b in contact with the second cathode active material layer 12b, and the anode layer 20 includes each of a first anode layer 20a in contact with the first solid electrolyte layer 30a and a second anode layer 20b in contact with the second solid electrolyte layer 30b, wherein the first solid electrolyte layer 30a and the second solid electrolyte layer 30b are opposite to each other, and the all-solid-state secondary battery 1 further includes the inactive member 40 disposed between the first solid electrolyte layer 30a and the second solid electrolyte layer 30b and surrounding a side of the cathode layer 10. Therefore, the all-solid-state secondary battery 1 has a bi-cell structure. The all-solid-state secondary battery 1 may have such a bi-cell structure, and thus the solid electrolyte layers 30 and the anode layers 20 may be disposed symmetrically with respect to the cathode layer 10 to be opposite to each other, thereby more effectively suppressing structural deformation or the like due to a pressure applied during manufacturing of the all-solid-state secondary battery 1. Therefore, cracks of the solid electrolyte layer 30 are suppressed during a manufacturing process and/or a charging/discharging process of the all-solid-state secondary battery 1, thereby preventing a short circuit in the all-solid-state secondary battery 1 and further improving the cycle characteristics of the all-solid-state secondary battery 1. In addition, only one cathode current collector 11 is used for a plurality of cathode active material layers 12a and 12b, and thus the energy density of the all-solid-state secondary battery 1 is increased.

### All-Solid-State Secondary Battery Structure

An all-solid-state secondary battery may additionally include an inactive stack member disposed on one side or two sides of the all-solid-state secondary battery to form an all-solid-state secondary battery structure.

The all-solid-state secondary battery structure may include, for example, one or more all- solid-state secondary batteries described above, and an inactive stack member disposed on one side or two sides of at least one of the all-solid-state secondary batteries.

The inactive stack member is disposed on one side or two sides of one all-solid-state secondary battery or a plurality of stacked all-solid-state secondary batteries to improve the structural stability of the all-solid-state secondary battery, thereby further improving the safety of the all-solid-state secondary battery structure.

The inactive stack member may include, for example, an elastic material. Since the inactive stack member includes the elastic material, the inactive stack member may effectively accommodate a change in volume that occurs during charging or discharging of the all-solid-state secondary battery. As a result, the deterioration of the all-solid-state secondary battery may be suppressed, and the lifespan characteristics of the all-solid-state secondary battery may be improved. The elastic material may be, for example, a polyurethane-based elastomer, a polyacrylic elastomer, or silicone-based rubber. The inactive stack member may include, for example, a moisture absorbent. Since the inactive stack member includes the moisture absorbent, the inactive stack member absorbs residual moisture in the all-solid-state secondary battery structure, thereby preventing the deterioration of the all-solid-state secondary battery structure and improving the lifespan characteristics of the all-solid-state secondary battery structure. The inactive stack member may include, for example, a conductive material. The inactive stack member includes the conductive material, thereby suppressing an increase in internal resistance of the all-solid-state secondary battery structure including a conductive flame-retardant inactive stack member and improving the cycle characteristics thereof. The inactive stack member may include one or more of the above-described elastic material, moisture absorbent, and conductive material.

The form of the inactive stack member is not particularly limited and may be selected according to the form of the all-solid-state secondary battery included in the all-solid-state secondary battery structure. The inactive stack member may be, for example, in the form of a sheet, a rod, or a gasket. The inactive stack member may be disposed, for example, on one side or two sides of one all-solid-state secondary battery. The inactive stack member may be disposed, for example, between a plurality of stacked all-solid-state secondary batteries. The inactive stack member may be disposed, for example, on the uppermost side and/or the lowermost side of the plurality of stacked all-solid-state secondary batteries.

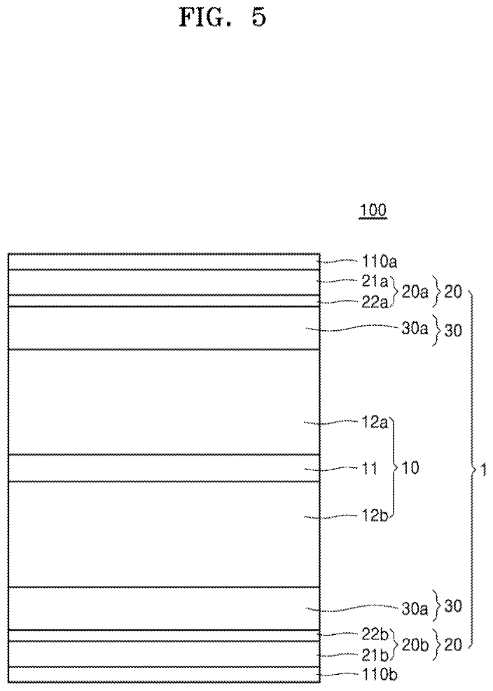

Referring to FIG. 5, an all-solid-state secondary battery structure 100 includes an all-solid-state secondary battery 1, and inactive stack members 110a and 110b disposed on both sides of the all-solid-state secondary battery 1. Although not shown in the drawing, the all-solid-state secondary battery structure 100 may include inactive stack members 110a and 110b disposed on one side of the all-solid-state secondary battery 1.

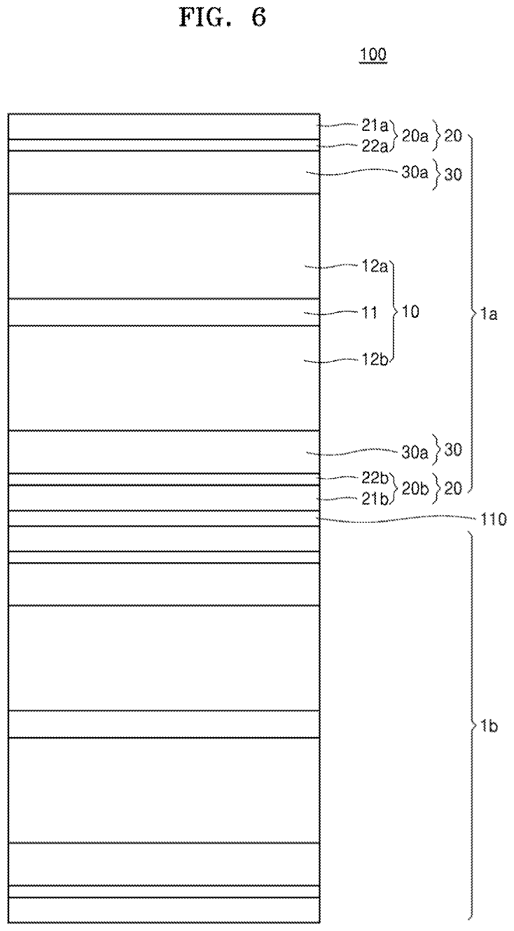

Referring to FIG. 6, an all-solid-state secondary battery structure 100 includes a plurality of all-solid-state secondary batteries 1a and 1b. An inactive stack member 110 is disposed, for example, between the all-solid-state secondary batteries 1a and 1b. Although not shown in the drawing, the inactive stack member 110 may be additionally disposed, for example, on the uppermost side or the lowermost side of the stacked all-solid-state secondary batteries 1a and 1b.

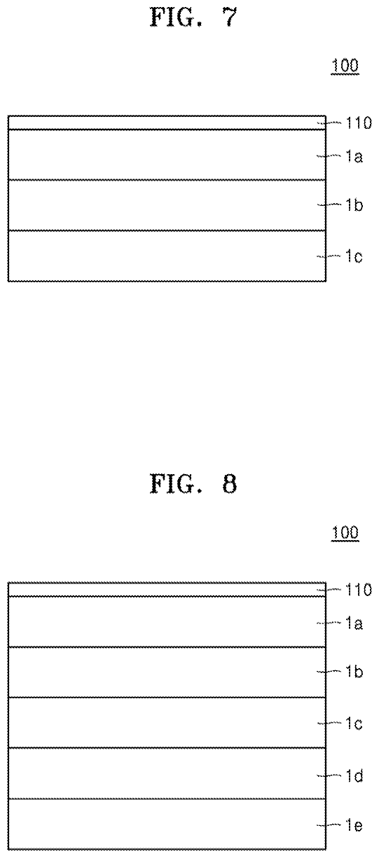

Referring to FIG. 7, an all-solid-state secondary battery structure 100 includes a plurality of stacked all-solid-state secondary batteries 1a, 1b, and 1c, and an inactive stack member 110 is disposed, for example, on the uppermost side or the lowermost side of a stack including the plurality of all-solid-state secondary batteries 1a, 1b, and 1c. Although not shown in the drawing, the inactive stack member 110 may be optionally disposed, for example, between one or more all-solid-state secondary batteries 1a, 1b, and 1c.

Referring to FIG. 8, an all-solid-state secondary battery structure 100 includes a plurality of stacked all-solid-state secondary batteries 1a, 1b, 1c, 1d, and 1e, and an inactive stack member 110 is disposed, for example, on the uppermost side or the lowermost side of a stack including the plurality of all-solid-state secondary batteries 1a, 1b, 1c, 1d, and 1e. Although not shown in the drawing, the inactive stack member 110 may be optionally disposed, for example, between one or more all-solid-state secondary batteries 1a, 1b, 1c, 1d, and 1e.

### Manufacturing of All-Solid-State Secondary Battery

### (Preparation of Solid Electrolyte Layer)

A method of manufacturing an all-solid-state secondary battery according to an embodiment includes dry-mixing a sulfide-based solid electrolyte, inorganic particles, and a binder to prepare a dry mixture, molding the dry mixture to prepare a solid electrolyte layer, and arranging the solid electrolyte layer between a cathode layer and an anode layer, wherein the inorganic particles have an average particle diameter of 50 nm to 5 μm or less. An all-solid-state secondary battery manufactured through the method may provide excellent discharge capacity and lifespan characteristics.

First, the sulfide-based solid electrolyte, the inorganic particles, and the binder are mixed to prepare the dry mixture. The dry-mixing means that mixing is performed in a state in which a process solvent is not included. The dry mixture refers to a mixture to which a process solvent is not intentionally added. The process solvent is, for example, a solvent used in preparing an electrode slurry. The binder is, for example, a dry binder. The dry binder refers to a binder that does not include a process solvent. The process solvent is, for example, water or N-methylpyrrolidone (NMP), but is not limited thereto. A process solvent material is not limited as long as the process solvent is used in preparing an electrode slurry. The dry-mixing may be performed, for example, at a temperature of 25° C. to 85° C. or 65° C. to 85° C. by using a stirrer. By using the stirrer, the dry-mixing may be performed, for example, at a rotational speed of 10 rpm to 10,000 rpm or 100 rpm to about 10,000 rpm. By using the stirrer, the dry-mixing may be performed, for example, for 1 minute to 200 minutes. The dry-mixing may be performed, for example, once or more. A dry mixture including a fibrillized dry binder may be obtained through the dry-mixing. The stirrer is, for example, a mixer or kneader. The stirrer includes, for example, a chamber, at least one rotating shaft disposed inside the chamber to rotate, and a blade rotatably coupled to the rotating shaft and disposed in a longitudinal direction of the rotating shaft. The blade may be, for example, at least one selected from a ribbon blade, a sigma blade, a Z blade, a dispersion blade, and a screw blade. By including the blade, without a solvent, an electrode active material, a dry conductive material, and a dry binder may be effectively mixed to prepare a dough-like mixture.

Next, the dry mixture may be molded to prepare the solid electrolyte layer. The prepared dry mixture may be put, for example, into an extrusion device and extruded in the form of a sheet. A pressure during the extrusion is, for example, in a range of 4 MPa to 100 MPa or 10 MPa to 90 MPa. The obtained mixture may be in the form of a sheet. That is, the obtained mixture in the form of a sheet may be the solid electrolyte layer. The extrusion device may be, for example, a roller or an extruder. The types and contents of the sulfide-based solid electrolyte, the inorganic particles, and the binder are as defined in the part of the above-described solid electrolyte layer. The binder may be omitted. For example, since sulfide-based solid electrolyte particles are partially sintered through pressing, the binder may be omitted.

### (Preparation of Anode Layer)

The anode layer may be prepared as a wet type in the same manner as a method of manufacturing an anode layer of a related art. For example, an anode active material, a conductive material, a binder, and a solvent are mixed to prepare an anode slurry. The anode slurry may be applied onto an anode current collector and then dried to prepare the anode layer. The solvent used in preparing the anode slurry is not particularly limited, and any solvent may be used as long as the solvent is used in an anode slurry in the art. The solvent used in the anode slurry is, for example, NMP. The types and contents of the anode current collector, the anode active material, the conductive material, and the binder are as defined in the part of the above-described anode layer.

### (Preparation of Cathode Layer)

The cathode layer may be prepared as a wet or dry type.

The cathode layer may be prepared, for example, as a wet type. A cathode active material, a sulfide-based solid electrolyte, a conductive material, a binder, and a solvent are mixed to prepare a cathode slurry. The cathode slurry may be applied onto a cathode current collector and then dried to prepare the cathode layer. The solvent used in preparing the cathode slurry is not particularly limited, and any solvent may be used as long as the solvent is used in a cathode slurry in the art. The solvent used in the cathode slurry is, for example, para-xylene. The types and contents of the cathode current collector, the cathode active material, the conductive material, and the binder are as defined in the part of the above-described cathode layer.

The cathode layer may be prepared, for example, as a dry type. First, the cathode active material, the sulfide-based solid electrolyte, the conductive material, and the binder are dry-mixed to prepare a dry mixture. Next, the dry mixture may be molded to prepare a cathode active material layer. Next, the prepared cathode active material layer is disposed on one side or two sides of a cathode current collector and pressed to prepare the cathode layer. The binder is, for example, a dry binder. The specific preparation conditions and method in the preparing of the dry mixture and the molding of the dry mixture are substantially the same as those of a method of preparing the above-described solid electrolyte layer. The types and contents of the cathode current collector, the cathode active material, the conductive material, and the binder are as defined in the part of the above-described cathode layer.

### (Manufacturing of All-Solid-State Secondary Battery)

The all-solid-state secondary battery may be manufactured, for example, as follows.

First, the solid electrolyte layer is disposed on the anode layer such that an anode active material layer is in contact with the solid electrolyte layer, thereby preparing an anode layer/solid electrolyte layer stack. Next, the solid electrolyte layer is disposed on one side or each of two sides of the cathode layer to face the cathode active material layer, thereby preparing an anode layer/solid electrolyte layer/cathode layer stack. The prepared anode layer/solid electrolyte layer/cathode layer stack is plate-pressed at a pressure of 300 MPa to 600 MPa at a temperature of 50° C. to 100° C. for 10 minutes to 60 minutes. Through such pressing, the solid electrolyte layer is partially sintered, thereby improving battery characteristics. The pressed stack is sealed with an exterior material to complete the all-solid-state secondary battery.

Alternatively, the all-solid-state secondary battery may be manufactured by further including an inactive member.

First, the solid electrolyte layer is disposed on the anode layer such that an anode active material layer is in contact with the solid electrolyte layer. A flame-retardant inactive member are disposed on the solid electrolyte layer to prepare an anode layer/solid electrolyte layer/inactive member stack. Next, the slid electrolyte layer is disposed on one side or each of two sides of the cathode layer such that the inactive member faces a cathode active material layer, thereby preparing an anode layer/solid electrolyte layer/cathode layer stack. The inactive member is disposed around the cathode layer to surround a side of the cathode layer and be in contact with the solid electrolyte layer. The inactive member is used as a gasket. The prepared anode layer/solid electrolyte layer/cathode layer stack is pressed (plate-pressed). The pressed stack is sealed with an exterior material to complete the all-solid-state secondary battery. The inactive member is as defined in the part of the above-described inactive member.

### MODE FOR INVENTION

The present inventive concept will be described in more detail through the following Examples and Comparative Examples. However, Examples are for illustrative purposes only, and the scope of the present inventive concept is not limited by Examples.

### Example 1: MgO (D50=0.5 μm), Li6PS5Cl (D50=10 μm), Dry Solid Electrolyte Layer

### (Preparation of Solid Electrolyte Layer, Dry Type)

1 part by weight of PTFE as a first binder, 1 part PVDF as a second binder, and 4.9 parts by weight of MgO (D50=0.5 μm), with respect to 93.1 parts by weight of a solid electrolyte, were added to a Li₆PS₅Cl sulfide-based solid electrolyte (D₅₀=10 μm, crystalline), which was an argyrodite-type crystal, put into a grind mixer, and mixed to prepare a mixture. The prepared mixture was put into a mortar heated to a temperature 80° C., and then stirred to prepare dough. The prepared dough was allowed to pass between rollers and molded into the form of a sheet to prepare a solid electrolyte film with a certain thickness. A solid electrolyte layer was prepared through such a process. Two solid electrolyte layers were prepared. A Young's modulus of MgO was 270 GPa. A Young's modulus of the sulfide-based solid electrolyte was in a range of about 15 GPa to about 30 GPa.

### (Preparation of Anode Layer)

Ni foil having a thickness of 10 μm was prepared as an anode current collector. In addition, CB particles with a primary particle diameter of about 30 nm and silver (Ag) particles with an average particle diameter (D50) of about 60 nm were prepared as an anode active material.

4 g of a mixed powder obtained by mixing the CB particles and the Ag particles at a weight ratio of 3:1 was put into a container, and 4 g of an NMP solution including 7 wt % of a PVDF binder (#9300 manufactured by Kureha Corporation) was added thereto to prepare a mixed solution. Next, while NMP was added little by little to the prepared mixed solution, the mixed solution was stirred to prepare a slurry. The prepared slurry was applied onto a SUS sheet by using a bar coater and dried in air at a temperature of 80° C. for 10 minutes. Thus, an obtained stack was vacuum-dried at a temperature of 40° C. for 10 hours. The dried stack was cold-roll-pressed to planarize a surface of a first anode active material layer of the stack. An anode layer was prepared through such a process. A thickness of the first anode active material layer included in the anode layer was about 7 μm. An area of the first anode active material layer was equal to an area of the anode current collector. Two anode layers were prepared.

### (Preparation of Cathode Layer)

LiNi_{0.8}Co_{0.15}Mn_{0.05}O₂ (NCM) coated with LZO was prepared as a cathode active material. The cathode active material coated with LZO was prepared according to a method disclosed in Korean Patent Publication No. 10-2016-0064942. Li₆PS₅Cl (D50=0.5 μm, crystalline), which was an argyrodite-type crystal, was prepared as a solid electrolyte. A PTFE binder was prepared as a binder. Carbon nanofibers (CNFs) were prepared as a conductive agent. A slurry, which was obtained by such materials that were mixed with a xylene solvent such that a weight ratio of cathode active material: solid electrolyte: conductive agent: binder was 84:11.5:3:1.5, was molded into the form of a sheet, and then the sheet was vacuum-dried at a temperature of 40° C. for 8 hours to prepare a cathode sheet. The prepared cathode sheet was disposed on each of two sides of a cathode current collector consisting of aluminum foil, of which two sides are coated with carbon, and heated and roll-pressed at a temperature of 85° C. to prepare cathode layers. The total thickness of the cathode layers was about 220 μm. A thickness of each of cathode active material layers was about 96 μm, and a thickness of the carbon-coated aluminum foil was about 28 μm. An area of the cathode active material layer was equal to an area of the cathode current collector.

### (Inactive Member)

A slurry obtained by mixing pulp fiber (cellulose fiber), glass fiber, aluminum hydroxide (Al(OH)₃), an acrylic binder, and a solvent was molded into the form of a gasket, and then the solvent was removed to prepare a flame-retardant inactive member.

A weight ratio of the pulp fiber (cellulose fiber), the glass fiber, the aluminum hydroxide (Al(OH)₃), and the acrylic binder was 20:8:70:2. A thickness of the inactive member was 120 μm. A prepared flame-retardant inactive member was left at room temperature for one week and then used.

The inactive member was subjected to vacuum heat treatment at a temperature of 80° C. for 5 hours to remove moisture or the like from the inactive member before being applied to an all-solid-state secondary battery.

### (Manufacturing of Bi-Cell All-Solid-State Secondary Battery)

Referring to FIG. 1, the solid electrolyte layer was disposed on the anode layer such that the first anode active material layer was in contact with the solid electrolyte layer. The flame-retardant inactive member was thermally pressed and disposed on the solid electrolyte layer to prepare two anode layer/solid electrolyte layer/inactive member stacks.

The anode layer/solid electrolyte layer/inactive member stack was disposed on each of two sides of the cathode layer such that the inactive member faces face the cathode active material layer, thereby preparing an anode layer/solid electrolyte layer/cathode layer stack. The inactive member was disposed around the cathode layer to surround a side of the cathode layer and be in contact with the solid electrolyte layer. The inactive member was used as a gasket.

The cathode layer was disposed at a central portion of the solid electrolyte layer, and the gasket was disposed to surround the cathode layer and extend to an end portion of the solid electrolyte layer. An area of the cathode layer was about 90% of an area of the solid electrolyte layer, and the gasket was disposed in the remaining 10% of the entire area of the solid electrolyte layer in which the cathode layer was not disposed. The solid electrolyte layer was disposed on the cathode layer and the gasket, and the anode layer was disposed on the solid electrolyte layer to prepare a stack.

A prepared anode layer/solid electrolyte layer/cathode layer stack was plate-pressed at a temperature of 85° C. and a pressure of 500 MPa for 30 minutes. Through such pressing, the solid electrolyte layer is sintered to improve battery characteristics. A thickness of one sintered solid electrolyte layer was about 45 μm. An area of the solid electrolyte layer was equal to an area of the anode layer.

An elastic pad in the form of a sheet having the same area and shape as the stack was disposed on each of one side of the pressed stack and the other side opposite to the one side as an inactive stack member. The elastic pad was a porous polyurethane sponge in the form of a sheet.

The stack to which the elastic pad added was put into a pouch and vacuum-sealed to manufacture a bi-cell all-solid-state secondary battery. Portions of the cathode current collector and the anode current collector protruded to the outside of the sealed battery to be used as a cathode layer terminal and an anode layer terminal.

An all-solid-state secondary battery to which an elastic pad is added corresponds to an all-solid-state secondary battery structure, but hereinafter, for convenience of description, it is referred to as an all-solid-state secondary battery.

### Example 2: MgO (D50=1.0 μm), Li₆PS₅Cl (D50=10 μm), Dry Solid Electrolyte Layer

An all-solid-state secondary battery was manufactured in the same manner as in Example 1, except that MgO (D50=0.5 μm) was changed into MgO (D50=1.0 μm).

### Example 3: MgO (D50=0.1 μm), Li₆PS₅Cl (D50=10 μm), Dry Solid Electrolyte Layer

An all-solid-state secondary battery was manufactured in the same manner as in Example 1, except that MgO (D50=0.5 μm) was changed into MgO (D50=0.1 μm).

### Example 4: MgO (D50=5 μm), Li₆PS₅Cl (D50=10 μm), Dry Solid Electrolyte Layer

An all-solid-state secondary battery was manufactured in the same manner as in Example 1, except that MgO (D50=0.5 μm) was changed into MgO (D50=5.0 μm).

### Example 5: MgO (D50=0.1 μm), Li₆PS₅Cl (D50=20 μm), Dry Solid Electrolyte Layer

An all-solid-state secondary battery was manufactured in the same manner as in Example 1, except that MgO (D50=0.5 μm) was changed into MgO (D50=0.1 μm) and Li₆PS₅Cl (D50=10 m) was changed into Li₆PS₅Cl (D50=20 μm).

### Example 6: MgO (D50=0.1 μm), Li₆PS₅Cl (D50=3 μm), Dry Solid Electrolyte Layer

An all-solid-state secondary battery was manufactured in the same manner as in Example 1, except that MgO (D50=0.5 μm) was changed into MgO (D50=0.1 μm) and Li₆PS₅Cl (D50=10 μm) was changed into Li₆PS₅Cl (D50=3 μm).

### Example 7: SiO₂ (D50=0.5 μm), Li₆PS₅Cl (D50=10 μm), Dry Solid Electrolyte Layer

An all-solid-state secondary battery was manufactured in the same manner as in Example 1, except that MgO (D50=0.5 μm) was changed into SiO₂ (D50=0.5 μm). A Young's modulus of SiO₂ was 95 GPa.

### Example 8: Al₂O₃ (D50=0.5 μm), Li₆PS₅Cl (D50=10 μm), Dry Solid Electrolyte Layer

An all-solid-state secondary battery was manufactured in the same manner as in Example 1, except that MgO (D50=0.5 μm) was changed into Al₂O₃ (D50=0.5 μm). A Young's modulus of Al₂O₃ was 400 GPa.

### Comparative Example 1: MgO (D50=0.03 μm), Dry Solid Electrolyte Layer

An all-solid-state secondary battery was manufactured in the same manner as in Example 1, except that MgO (D50=0.03 μm) was used instead of MgO (D50=0.5 μm).

### Comparative Example 2: MgO (D50=7 μm), Dry Solid Electrolyte Layer

An all-solid-state secondary battery was manufactured in the same manner as in Example 1, except that MgO (D50=7.0 μm) was used instead of MgO (D50=0.5 μm).

### Comparative Example 3: Non-Use of Inorganic Particles, Li₆PS₅Cl (D50=10 μm), Wet Solid Electrolyte Layer

An all-solid-state secondary battery was manufactured in the same manner as in Example 1, in which MgO (D50=0.5 μm) was not used and a solid electrolyte layer was prepared as a wet type.

A wet solid electrolyte layer was prepared through the following method.

### (Preparation of Solid Electrolyte Layer)

A mixture was prepared by adding 2 parts by weight of an acrylic binder with respect to 98 parts by weight of a solid electrolyte to a Li₆PS₅Cl solid electrolyte (D50=10 m, crystalline) which was an argyrodite-type crystal. Octyl acetate was added to the prepared mixture and stirred to prepare a slurry. The prepared slurry was applied onto a nonwoven fabric by using a bar coater and dried in air at a temperature of 80° C. for 10 minutes to obtain a stack. The obtained stack was vacuum-dried at a temperature of 80° C. for 2 hours. A solid electrolyte layer was prepared through such a process.

### Comparative Example 4: Non-Use of Inorganic Particles, Li₆PS₅Cl (D50=20 μm), Wet Solid Electrolyte Layer

An all-solid-state secondary battery was manufactured in the same manner as in Comparative Example 3, except that Li₆PS₅Cl (D50=10 μm) was changed into Li₆PS₅Cl (D50=20 μm).

### Comparative Example 5: Non-use of inorganic particles, Li₆PS₅Cl (D50=3 μm), use of PVDF dissolved in NMP, wet solid electrolyte layer

An all-solid-state secondary battery was manufactured in the same manner as in Example 1, in which MgO (D50=0.5 μm) was not used and a solid electrolyte layer was prepared as a wet type.

A wet solid electrolyte layer was prepared through the following method.

### (Preparation of Solid Electrolyte Layer)

A mixture was prepared by adding 2 parts by weight of PVDF as a second binder with respect to 98 parts by weight of a solid electrolyte to a Li₆PS₅Cl solid electrolyte (D50=10 μm, crystalline) which was an argyrodite-type crystal. NMP was added to the prepared mixture and stirred to prepare a slurry. The prepared slurry was applied onto a nonwoven fabric by using a bar coater and dried in air at a temperature of 80° C. for 10 minutes to obtain a stack. The obtained laminate was vacuum dried at 80° C. for 2 hours. A solid electrolyte layer was prepared through such a process.

### Comparative Example 6: Non-Use of Inorganic Particles, Li₆PS₅Cl (D50=3 μm), Second Binder Alone, Dry Solid Electrolyte Layer

An all-solid-state secondary battery was manufactured in the same manner as Example 1, except that MgO (D50=0.5 μm) was not used, Li₆PS₅Cl (D50=10 μm) was changed into Li₆PS₅Cl (D50=3 μm), a first binder (PTFE) was omitted, and 2 parts by weight of a second binder (PVDF) was used. It was impossible to prepare a dry solid electrolyte layer because the first binder (PTFE), which was a fibrillized binder, was not included.

### Comparative Example 7: Non-Use of Inorganic Particles, Li₆PS₅Cl (D50=3 μm), First Binder Alone, Dry Solid Electrolyte Layer

An all-solid-state secondary battery was manufactured in the same manner as Example 1, except that MgO (D50=0.5 μm) was not used, Li₆PS₅Cl (D50=10 μm) was changed into Li₆PS₅Cl (D50=3 μm), 2 parts by weight of a first binder (PTFE) was used, and a second binder (PVDF) was omitted.

### Comparative Example 8: Non-Use of Inorganic Particles, Li₆PS₅Cl (D50=3 μm), Mixing of First Binder and Second Binder, Dry Solid Electrolyte Layer

An all-solid-state secondary battery was manufactured in the same manner as Example 1, except that MgO (D50=0.5 μm) was not used, Li₆PS₅Cl (D50=10 μm) was changed into Li₆PS₅Cl (D50=3 μm), 1.5 parts by weight of a first binder (PTFE) was used, and 0.5 parts by weight of a second binder (PVDF) was used.

### Comparative Example 9: Non-Use of Flame-Retardant Inactive Member (Free)

An all-solid-state secondary battery was manufactured in the same manner as in Comparative Example 8, except that a gasket (that is, a flame-retardant inactive member) was not used when the all-solid-state secondary battery was manufactured.

### Evaluation Example 1: Charge/Discharge Test

The charge/discharge characteristics of the all-solid-state secondary batteries manufactured in Example 1 to 8 and Comparative Examples 1 to 9 were evaluated through the following charge/discharge test. The charge/discharge test was performed by put the all-solid-state secondary batteries into a thermostatic bath at a temperature of 45° C.

In a 1^{st} cycle, charging was performed at a constant current of 0.1 C until a battery voltage reached 3.9 V to 4.25 V, and when the battery voltage reached 4.25 V, constant voltage charging was performed at 4.25 V under a 0.05 C cut-off condition. Next, discharging was performed at a constant current of 0.1 C until the battery voltage reached 2.5 V.

In a 2^{nd} cycle, charging was performed at a constant current of 0.33 C until the battery voltage reached 4.25V, and when the battery voltage reached 4.25 V, constant voltage charging was performed at 4.25 V under a 0.05 C cut-off condition. Next, discharging was performed at a constant current of 0.33 C until the battery voltage reached 2.5 V.

A discharge capacity of the 1^{st} cycle was taken as a standard capacity. After the 2^{nd} cycle, charging and discharging were performed up to a 100^{th} cycle under the same conditions as the 1^{st} cycle.

The number of cycles at which a discharge capacity reaches 95% of the standard capacity after the 2^{nd} cycle is shown in Table 2 below. This means that as the number of cycles increases, lifespan characteristics improve.

When a short circuit occurs before the 1^{st} cycle is completed, the short circuit is denoted by ○, and when a short circuit does not occur until the 1^{st} cycle is completed, the short circuit is denoted by x.

TABLE 1

| | | Standard | Number of |
|---|---|---|---|
| | Short | capacity | cycles |
| | circuit | [mAh/g] | [times] |
| Example 1 (0.5 μm MgO, dry type, 10 μm solid | x | 187.0 | 55 |
| electrolyte) | | | |
| Example 2 (1.0 μm MgO, dry type, 10 μm solid | x | 183.0 | 50 |
| electrolyte) | | | |
| Example 3 (0.1 μm MgO, dry type, 10 μm solid | x | 184.0 | 45 |
| electrolyte) | | | |
| Example 4 (5.0 μm MgO, dry type, 10 μm solid | x | 176 | 38 |
| electrolyte) | | | |
| Example 5 (0.1 μm MgO, dry type, 20 μm solid | x | 186.0 | 50 |
| electrolyte) | | | |
| Example 6 (0.1 μm MgO, dry type, 3 μm solid | x | 182.0 | 40 |
| electrolyte) | | | |
| Example 7 (0.5 μm SiO₂, dry type, 10 μm solid | x | 184.0 | 50 |
| electrolyte) | | | |
| Example 8 (0.5 μm Al₂O₃, dry type, | x | 185.0 | 52 |
| 10 μm solid electrolyte) | | | |
| Comparative Example 1 (0.03 μm MgO, dry type, 10 | x | 120.0 | 10 |
| μm solid electrolyte) | | | |
| Comparative Example 2 (7 μm MgO, dry type, 10 | x | 135.0 | 28 |
| μm solid electrolyte) | | | |
| Comparative Example 3 (0% MgO, wet type, 10 μm | x | 78.0 | 5 |
| solid electrolyte) | | | |
| Comparative Example 4 (0% MgO, wet type, 20 μm | x | 68.0 | 3 |
| solid electrolyte) | | | |
| Comparative Example 5 (0% MgO, wet type, 3 μm | x | 80.0 | 2 |
| solid electrolyte) | | | |
| Comparative Example 6 (0% MgO, dry type, 0% | Impossible | Unmeasurable | — |
| PTFE, 2% PVDF) | to prepare | | |
| | cathode | | |
| Comparative Example 7 (0% MgO, dry type, 2% | x | 166.3 | 25 |
| PTFE, 0% PVDF) | | | |
| Comparative Example 8 (0% MgO, dry type, 1.5% | x | 120.0 | 10 |
| PTFE, 0.5% PVDF) | | | |
| Comparative Example 9 (0% MgO, dry type, 1.5% | ∘ | Unmeasurable | — |
| PTFE, 0.5% PVDF, non-use of inactive material) | | | |

As shown in Table 1, the all-solid-state secondary batteries of Examples 1 to 8 showed improved stability, discharge capacity, and lifespan characteristics as compared with the all-solid-state secondary batteries of Comparative Examples 1 to 9. In the all-solid-state secondary battery of Comparative Example 6 which did not include the first binder, it was impossible to prepare a cathode.

In the all-solid-state secondary battery of Comparative Example 9 which did not include a flame-retardant inactive member gasket, a short circuit occurred during a charging or discharging process.

After the 1^{st} cycle of charging was completed in the all-solid-state secondary batteries of Examples 1 to 8, a scanning electron microscope (SEM) image of a cross section of each of the batteries was measured to confirm that a lithium metal-plated layer corresponding to a second anode active material layer was formed between a first anode active material layer and the solid electrolyte layer.

As described above, the all-solid-state secondary battery according to the present embodiment may be applied to various portable devices, vehicles, and the like.

While embodiments have been described in detail with reference to the accompanying drawings, the present inventive concept is not limited to the embodiments. It is obvious to those skilled in the art to which the present inventive concept belongs that various changes and modifications are conceivable within the scope of the technical idea described in the claims, and those are understood as naturally belonging to the technical scope of the present inventive concept.

[EXPLANATION OF REFERENCE NUMERALS DESIGNATING
THE MAJOR ELEMENTS OF THE DRAWINGS]

| | |
|---|---|
| 1: all-solid-state secondary battery | 10: cathode layer |
| 11: cathode current collector | 12: cathode active material layer |
| 20: anode layer | 21: anode current collector |
| 22: first anode active material layer | 30: solid electrolyte layer |
| 40: inactive member | 100: all-solid-state secondary |
| | battery structure |
| 110: inactive stack member | |

### INDUSTRIAL APPLICABILITY

According to an aspect, according to an all-solid-state secondary battery, there may be provided the all-solid-state secondary battery in which a short circuit is prevented and which has improved discharge capacity and lifespan characteristics.

1. An all-solid-state secondary battery comprising:
a cathode layer;
an anode layer; and
a solid electrolyte layer disposed between the cathode layer and the anode layer,
wherein the solid electrolyte layer comprises a sulfide-based solid electrolyte and inorganic particles,
wherein the inorganic particles have an average particle diameter of 50 nm to 5 μm or less.

2. The all-solid-state secondary battery of claim 1, wherein:
a Young's modulus of the inorganic particles is greater than that of the sulfide-based solid electrolyte,
the inorganic particles have a Young's modulus of 50 GPa to 1,000 GPa, and
the sulfide-based solid electrolyte has a Young's modulus of 40 GPa or less.

3. The all-solid-state secondary battery of claim 1, wherein the inorganic particles are inert with respect to the sulfide-based solid electrolyte and are free of lithium ion conductivity.

4. The all-solid-state secondary battery of claim 1, wherein the inorganic particles comprise a metal oxide.

5. The all-solid-state secondary battery of claim 1, wherein the inorganic particles comprise MgO, SiO₂, Al₂O₃, TiO₂, Ti₂O₃, ZrO₂, ZnO, B₂O, B₂O₃, Ga₂O₃, TeO, TeO₃, Cs₂O, SnO, SnO₂, CrO₃, Cr₂O₃, BeO, FeO, Fe₂O₃, BaO, PbO, PbO₂, Pb₂O₃, or Pb₃O₄.

6. The all-solid-state secondary battery of claim 1, wherein a content of the inorganic particles is in a range of 1 wt % to 10 wt % with respect to a total weight of the solid electrolyte layer.

7. The all-solid-state secondary battery of claim 1, wherein:
the sulfide-based solid electrolyte comprises a plurality of sulfide-based solid electrolyte particles, and
the inorganic particles are disposed between the plurality of sulfide-based solid electrolyte particles.

8. The all-solid-state secondary battery of claim 7, wherein the sulfide-based solid electrolyte particles have an average particle diameter of 1 μm to 50 μm.

9. The all-solid-state secondary battery of claim 7, wherein a particle diameter ratio of the sulfide-based solid electrolyte particles to the inorganic particles is in a range of 1:2 to 1:200.

10. The all-solid-state secondary battery of claim 1, wherein the sulfide-based solid electrolyte comprises at least one selected from Li₂S-P₂S₅, Li₂S-P₂S₅-LiX, wherein X is a halogen element, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ, wherein m and n are each a positive number and Z is one of Ge, Zn, and Ga, Li₂S-GeS₂, Li₂S-SiS₂-Li₃PO₄, Li₂S-SiS₂-LiₚMO_{q}, wherein p and q are each a positive number and M is one of P, Si, Ge, B, Al, Ga, and In, Li₃PS₄, Li₇P₃S₁₁, Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2.

11. The all-solid-state secondary battery of claim 1, wherein the solid electrolyte layer further comprises at least one binder, wherein the at least one binder comprises at least one selected from a conductive binder and a non-conductive binder.

12. The all-solid-state secondary battery of claim 11, wherein:
the at least one binder comprises a first binder, and
the first binder includes a fibrillized fluorine-based dry binder.

13. The all-solid-state secondary battery of claim 12, wherein:
the at least one binder further comprises a second binder, and
the second binder includes a non-fibrillized fluorine-based dry binder.

14. The all-solid-state secondary battery of claim 11, wherein a content of the binder is in a range of 1 wt % to 10 wt % with respect to a total weight of the solid electrolyte layer.

15. The all-solid-state secondary battery of claim 1, wherein the solid electrolyte layer is free of a residual process solvent.

16. The all-solid-state secondary battery of claim 1, wherein:
the anode layer comprises: an anode current collector; and a first anode active material layer disposed on the anode current collector,
the first anode active material layer comprises an anode active material and a binder, and
the anode active material is in a particle form and an average particle diameter of 4 μm or less.

17. The all-solid-state secondary battery of claim 16, wherein:
the anode active material comprises at least one selected from a carbon-based anode active material and a metal or metalloid anode active material,
the carbon-based anode active material comprises amorphous carbon, and the metal or metalloid anode active material comprises gold (Au), platinum (Pt), palladium (Pd), silicon (Si), silver (Ag), aluminum (Al), bismuth (Bi), tin (Sn), or zinc (Zn).

18. The all-solid-state secondary battery of claim 16, further comprising a second anode active material layer disposed between the anode current collector and the first anode active material layer,
wherein the second anode active material layer is a metal layer comprising lithium or a lithium alloy and is a plated layer.

19. The all-solid-state secondary battery of claim 1, wherein:
the cathode layer comprises a cathode current collector and a first cathode active material layer and a second cathode active material layer respectively disposed on both sides of the cathode current collector,
the solid electrolyte layer comprises a first solid electrolyte layer and a second solid electrolyte layer in contact with the first cathode active material layer and the second cathode active material layer, respectively,
the anode layer comprises a first anode layer and a second anode layer in contact with the first solid electrolyte layer and the second solid electrolyte layer, respectively,
the first solid electrolyte layer and the second solid electrolyte layer are opposite to each other, and
the all-solid-state secondary battery further comprises an inactive member disposed between the first solid electrolyte layer and the second solid electrolyte layer and surrounding a side of the cathode layer.

20. A method of manufacturing an all-solid-state secondary battery, the method comprising:
dry-mixing a sulfide-based solid electrolyte, inorganic particles, and a binder to prepare a dry mixture;
molding the dry mixture to preparing a solid electrolyte layer; and
arranging the solid electrolyte layer between a cathode layer and an anode layer,
wherein the inorganic particles have an average particle diameter of 50 nm to 5 μm or less.
